(19) United States
(12) Patent Application Publication
(10) Pub. No.: US 2003/0184147 A1
(43) Pub. Date: Oct. 2, 2003

(54) Method and system to provide coastdown braking torque to an electrically propelled vehicle without regenerative braking

(75) Inventor: Asi Perach, Farmington Hills, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Motor Company, Dearborn, MI (US)

(21) Appl. No.: 10/063,155

(22) Filed: Mar. 26, 2002

(51) Int. Cl. B60T 13/66

(52) U.S. Cl. 303/20

(57) ABSTRACT

The invention is a coastdown braking strategy for an electrically propelled vehicle without using an ability to absorb regenerative braking energy. The strategy simulates engine braking force such as when no braking or accelerator force is applied. The strategy can be activated in response to operator release of both the accelerator and brake and deactivated at a predetermined motor speed or when the accelerator or brake are applied. Deactivation in one embodiment can be gradually diminished to zero braking torque based on predetermined threshold values of driver expectation. The braking force for the strategy is provided by an ABS system and can be applied to all wheels or just the rear wheels.

### BACKGROUND OF INVENTION

The present invention relates generally to electrically propelled vehicles and particularly to a method and system to provide coastdown raking torque to an electrically propelled vehicle that does not have the ability to absorb regenerative braking energy.

The need to reduce fossil fuel consumption and emissions in automobiles and other vehicles predominately powered by internal combustion engines (ICEs) is well known. Vehicles powered by electric motors attempt to address these needs. Other alternative solutions combine a smaller ICE with electric motors into one vehicle. Such vehicles combine the advantages of an ICE vehicle and an electric vehicle and are typically called hybrid electric vehicles (HEVs). See generally, U.S. Pat. No. 5,343,970 to Severinsky.

In an effort to find energy sources in addition to batteries to power these electric motors, fuel cells, using an electrochemical reaction to generate electricity, are becoming an attractive energy alternative. Fuel cells offer low emissions, high fuel energy conversion efficiencies, and low noise and vibrations. U.S. Pat. No. 5,248,566 to Kumar et al. Of the various types of fuel cell types, the proton electrolyte membrane (PEM) fuel cell appears to be the most suitable for use in automobiles, as it can produce potentially high energy, and has low weight and volume. These vehicles can eliminate the need for an ICE altogether.

Some of these new types of powertrain configurations allow the addition of regenerative braking (regen). Regen captures the kinetic energy of the vehicle as it decelerates. In conventional vehicles, kinetic energy is usually dissipated as heat at the vehicle's brakes or engine during deceleration. Regen converts the captured kinetic energy through a generator into electrical energy in the form of a stored charge in the vehicle's battery. This stored energy is used later to power the electric motor. Consequently, regen also reduces fuel usage and emission production. In certain vehicle configurations, the engine can be disconnected from the rest of the powertrain thereby allowing more of the kinetic energy to be converted into stored electrical energy.

Successful implementation of any of the new types of powertrain configurations must consider, among other things, driver expectation and the effects of ICE braking on the vehicle. This engine braking is well known during an ICE vehicle coastdown with no accelerator pedal or brake pedal depression. Engine braking is typically characterized by two types of negative powertrain torques including engine friction and pumping losses. Both types of losses result from the engine being driven by the wheels through the powertrain. Engine friction losses result from the piston rings sliding along the cylinder walls and rotation in the bearings of the engine. Engine pumping refers to the compression of the air in each of the engine's cylinders as the engine moves through its stroke. Engine braking allows the driver to reduce vehicle speed without applying force to the brake pedal.

U.S. Pat. No. 6,122,588 to Shehan, et al. discloses a system and method for controlling the speed of a vehicle using continuously variable braking torque to maintain a predetermined set speed. The system is applicable to electrical vehicles, and the braking torque may be applied using regenerative braking and/or friction brakes. Shehan further discloses a controller able to receive various signals from sensors to monitor current operating conditions of the vehicle, including motor speed, and a braking device implemented by a traction motor/generator and directly coupled to one or more wheels by a hydraulic linkage. Shehan does not, however, address a coastdown strategy to mimic engine braking.

U.S. Pat. No. 6,099,089 to Schneider discloses a method and apparatus for regenerative and friction braking. A brake control unit works in communication with and cooperatively with a drive motor control unit to control the front and rear brakes to establish a desired braking condition in accordance with anti-lock brake systems (ABS).

In some applications such as fuel cells, regen strategies may not be needed at all times. In these applications, an air-cooled resistor may absorb the excess regen energy instead of applied to the charge of the battery, or the regen strategy can simply be bypassed.

There remains a need for a method of providing coastdown-aking torque to an electrically propelled vehicle that is not equipped to absorb regenerative braking energy, the regenerative braking system has failed for whatever reason, or the regen system has been bypassed.

### SUMMARY OF INVENTION

Accordingly, the present invention is a system and method to provide coastdown-b aking torque to an electrically propelled vehicle without using an ability to absorb regenerative braking energy.

The present invention simulates engine coastdown braking for an electric vehicle using an anti-lock braking system (ABS) for a vehicle with at least one front wheel and at least one rear wheel; a motor speed sensor attached to the motor; an accelerator; an accelerator position sensor attached to the accelerator; a brake means; a brake means position sensor attached to the brake means; mechanical brakes comprising an anti-lock braking system (ABS) mechanically connected to the wheels and capable of providing negative torque to the wheels when activated; a controller in communication with the accelerator position sensor, the brake means position sensor, the motor speed sensor, and the mechanical brakes; and a strategy within the controller, activated in response to communication from the brake means position sensor and the accelerator position sensor that both are released, that activates a coastdown strategy that applies the ABS to at least one wheel.

The system can be deactivated in response to communication from the motor speed sensor that the motor speed is below a predetermined threshold. On one embodiment, the coastdown strategy can be deactivated gradually to zero braking torque based on predetermined threshold values of driver expectation. Deactivation can also occur when the system senses the operator has applied the mechanical brakes or accelerator.

The present invention can be controlled by an electric hydraulic braking (EHB) unit, a vehicle system controller (VSC), or a combination of the two. Communication within the vehicle can be through a controller area network (CAN).

In one embodiment, the ABS is applied to at least one rear wheel when the system is activated. In another embodiment, the ABS is applied to all wheels.

Other objects of the present invention will become more apparent to persons having ordinary skill in the art to which the present invention pertains from the following description taken in conjunction with the accompanying figures.

### BRIEF DESCRIPTION OF DRAWINGS

The foregoing objects, advantages, and features, as well as other objects and advantages, will become apparent with reference to the description and figures below, in which like numerals represent like elements and in which:

FIG. 1 illustrates a possible system configuration for the present invention.

FIG. 2 is a flow chart illustrating the control logic for one embodiment of the present invention.

### DETAILED DESCRIPTION

The present invention relates to electric vehicles and describes an effective strategy to provide coastdown braking torque to an electrically propelled vehicle without using a means to absorb the regenerative braking energy. The coast own braking strategy of the present invention simulates the braking force of a conventional internal combustion engine such as when no braking or accelerator force is applied. The invention can be applied to a vehicle that has no regenerative capability, the regenerative braking strategy has failed, or the regenerative braking strategy is, for whatever reason, bypassed.

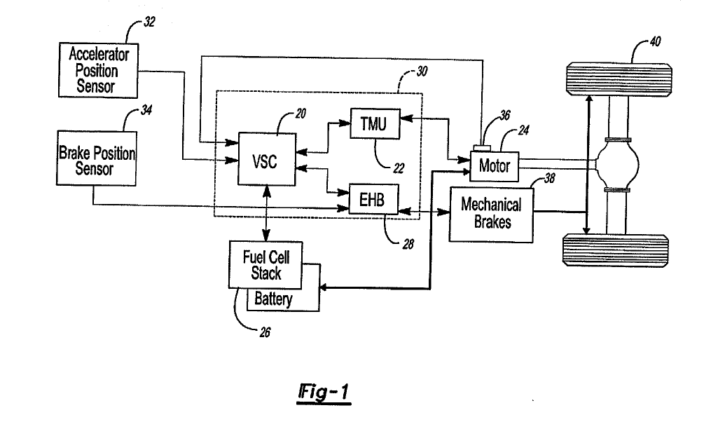

FIG. 1 illustrates a possible system configuration for the present invention. A vehicle system controller (VSC) 20 controls many vehicle components by connecting to each component's controller. All vehicle controllers can be physically combined in any combination or can stand as separate units. In the example illustrated in FIG. 1, a transaxle management unit (TMU) 22 connects to a motor 24 via a hardwire interface. The motor 24 is mechanically connected to a set of wheels 40 and electrically connected to a fuel cell stack and/or battery 26 although the present invention could apply to any means to supply electricity. The configuration as shown shows the ability of the motor 24 to generate electricity to the battery 26 but this feature would not be utilized during the coastdown strategy of the present invention.

The VSC 20 communicates with the TMU 22, as well as the fuel cell stack 26 and an electric hydraulic braking (EHB) unit 28 through a communication network such as a controller area network (CAN) 30. The EHB 28 is connected to mechanical brakes 38 that ultimately are connected to the vehicle wheels 40. The EHB 28 can control anti-lock braking systems (ABS), regenerative braking, traction control, and normal braking. The EHB 28 can receive input for a brake means position sensor 34 (such as a brake pedal).

The VSC 20 can also receive input from various vehicle components. Specific to the present invention are inputs for an accelerator position sensor 32 (such as an accelerator pedal), and motor speed sensor 36 (connected to the motor 24).

The present invention uses the EHB 28 to direct the anti-lock braking system (ABS) (not shown) within the mechanical brakes 38 to provide a braking force to the vehicle's wheels 40 to simulate engine braking. An advantage of using the ABS is that it can provide a light coastdown braking torque without requiring any additional vehicle hardware since the EHB 28 has a hydraulic pump and actuation valves well known in the prior art. The hydraulic pump can provide hydraulic pressure to brake calipers, or brake drums, (not shown) without a brake request from a vehicle operator. The hydraulic pressure calipers provide clamping force on disk or drum brakes thus providing a braking torque to the selected wheels 40. A coastdown strategy to simulate engine braking is easily integrated into the EHB 28 since a similar traction control function is often part of the overall anti-lock braking system.

The coastdown strategy must provide proportional forces to slow the vehicle in relation to driver expectation based on accelerator position sensor 32 output, brake position sensor 34 output, and motor speed sensor 36 output. As a vehicle slows, the amount of braking torque can be deactivated or gradually diminished to zero using a set predetermined value or values based on driver expectation.

The coastdown strategy of the present invention can be designed in a number of configurations based a selection of wheels used to provide the braking torque and predicted driver expectation. In one embodiment, only the rear wheels are used for the braking force. Rear wheel brake pads are not used as aggressively as front brake pads in the normal operation of a vehicle. Therefore, rear pads wear rate is typically lower then than the front pads wear rate. This allows the opportunity to use rear wheel brake pads while potentially not reducing brake pad life of the pads on the front wheels. In a second embodiment, all wheels can be included to provide the braking force, thus distributing brake pad wear in the same proportion as is expected in conventional vehicles (i.e., the front pads wear out first).

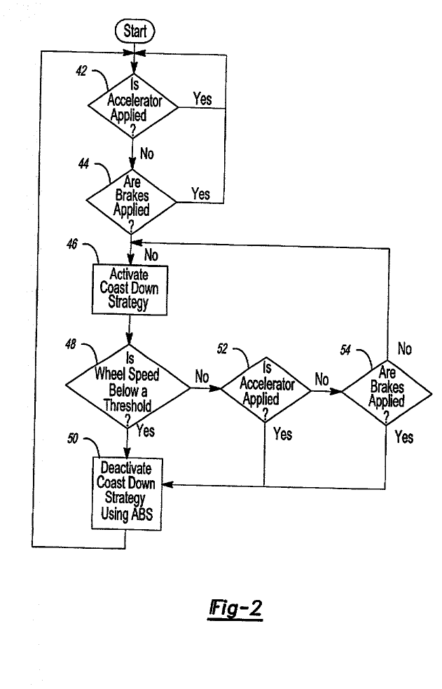

FIG. 2 is a flow chart illustrating the control logic for one embodiment of the present invention and can be included as part of the EHB 28 or as part of the VSC 20. The strategy starts with each “key-on” event and ends with a “key-off.” The strategy begins at step 42 with a determination of whether the vehicle accelerator is applied using data from the accelerator position sensor 32. If yes, the strategy cycles back to step 42. If no, the strategy determines whether the brakes are applied at step 44 using data from the brake position sensor 34. If yes, the strategy cycles back to step 42. If no, the strategy commands the coastdown strategy to be activated at step 46. This strategy, as stated above, uses the ABS within the mechanical brakes 38 to provide sufficient braking torque to selected wheels 40 to simulate engine coastdown braking torque based on driver expectation.

Once the coastdown strategy is activated in step 46, the overall control logic continues to monitor vehicle conditions. At step 48 the strategy determines whether wheel (vehicle) speed is below a predetermined threshold based on data from the motor speed sensor 36. The wheel speed, derived from the motor speed sensor 36, can be used to detect whether any braking force is expected by the vehicle operator. If yes (i.e., motor speed is below the predetermined threshold), the strategy deactivates the coastdown strategy at step 50 and cycles back to step 42. If no, the strategy determines at step 52 whether the vehicle accelerator is applied, again using data from the accelerator position sensor 32. If no, the strategy determines at step 54 whether the brakes are applied using data from the brake position sensor 32. If yes, the strategy cycles to step 50 and deactivates the coastdown strategy. At step 54, if the strategy determines the brakes are not applied, the strategy returns to step 46.

The above-described embodiment of the invention is provided purely for purposes of example. Many other variations, modifications, catalysts, and applications of the invention may be made.

1. A method to simulate engine coastdown braking for an electric powered vehicle, comprising the steps of:
determining when a vehicle accelerator and brake are both released;
activating a coastdown strategy when the accelerator and brake are both released; and
applying a braking torque that simulates engine coastdown braking to at least one vehicle wheel using an anti-lock braking system when the coastdown strategy is activated.

2. The method of claim 1, further comprising the step of deactivating the coastdown strategy when the accelerator and brake are not both released.

3. The method of claim 1, further comprising the step of deactivating the coastdown strategy when a motor speed sensor determines that a motor speed is below a predetermined threshold.

4. The method of claim 3, wherein the step of deactivating the coastdown strategy further comprises the step of gradually diminishing to a zero braking torque based on predetermined threshold values of driver expectation.

5. A system to simulate engine coastdown braking for an electric powered vehicle, comprising:
a controller to determine when a vehicle accelerator and brake are both released, and generate a braking torque request to an anti-lock braking system that simulates engine coastdown when the accelerator and brake are both released; and
the anti-lock braking device coupled to at least one vehicle wheel for applying the braking torque in response to braking torque request.

6. The system of claim 5, wherein the controller further comprises a deactivation request of the braking torque request when the accelerator and brake are not both released.

7. The system of claim 5, wherein the controller further comprises a deactivation request of the braking torque request when a motor speed sensor determines that a motor speed is below a predetermined threshold.

8. The system of claim 7, wherein the deactivation request comprises a request to gradually diminishing braking torque to a zero based on predetermined threshold values of driver expectation.

9. The system of claim 5, wherein the controller comprises an electric hydraulic braking (EHB) unit.

10. The system of claim 5, wherein the controller comprises a vehicle system controller (VSC).

11. The system of claim 5, wherein the controller comprises a vehicle system controller (VSC) and an electric hydraulic braking (EHB) unit.

12. The system of claim 5, wherein the controller further comprises a controller area network (CAN).

13. The system of claim 5, wherein the anti-lock braking system applies braking torque to at least one rear wheel.

14. The system of claim 5, wherein the anti-lock braking applies braking torque to all wheels.

15. A vehicle comprising:
a controller to determine when a vehicle accelerator and brake are both released, and generate a braking torque request to an anti-lock braking system that simulates engine coastdown when the accelerator and brake are both released; and
the anti-lock braking device coupled to at least one vehicle wheel for applying the braking torque in response to braking torque request.
